(19) United States
(12) Patent Application Publication
(10) Pub. No.: US 2025/0142350 A1
(43) Pub. Date: May 1, 2025

(54) WIRELESS COMMUNICATION METHOD AND COMMUNICATION DEVICE

(71) Applicant: GUANGDONG OPPO MOBILE TELECOMMUNICATIONS CORP., LTD., Dongguan (CN)

(72) Inventors: Yi ZHANG, Dongguan (CN); Jing XU, Dongguan (CN); Yanan LIN, Dongguan (CN); Bin LIANG, Dongguan (CN)

(73) Assignee: GUANGDONG OPPO MOBILE TELECOMMUNICATIONS CORP., LTD., Dongguan (CN)

(21) Appl. No.: 19/005,373

(22) Filed: Dec. 30, 2024

Related U.S. Application Data
(63) Continuation of application No. PCT/CN2022/104659, filed on Jul. 8, 2022.

(51) Int. Cl. H04W 16/14; H04W 4/02

(52) U.S. Cl. CPC H04W 16/14; H04W 4/02

(57) ABSTRACT

Provided are a wireless communication method and a communication device. The wireless communication method comprises: a first node sending first sensing assistance information corresponding to a first sensing node, wherein the first sensing assistance information comprises one or more items of the following information of the first sensing node: sensing capability information, operating bandwidth information, sensing precision information, transmit power information, electric quantity information, resource occupancy information, indication information of expecting or not expecting to participate in sensing, location information, or information for matching with sensed targets.

This application is a continuation of International Application No. PCT/CN2022/104659, filed on Jul. 8, 2022, the disclosure of which is hereby incorporated by reference in its entirety.

### TECHNICAL FIELD

This application relates to the field of communication technologies, and more specifically, to a wireless communication method and a communication device.

### BACKGROUND

A network (such as a 6th generation (6th generation, 6G) network) may be developed into a fusion of at least two of a mobile communication network, a sensing network, and a computing power network. In some cases, some problems arise in a communication-sensing integrated system. For example, in the communication-sensing integrated system, there may be a plurality of nodes with sensing capabilities around a sensed target. These nodes may not be each suitable for sensing the sensed target and/or a sensed service, and the like. If an unsuitable node is selected to participate in sensing the sensed target and/or the sensed service, problems such as low sensing efficiency and unsatisfactory sensing results may occur.

### SUMMARY

This application provides a wireless communication method and a communication device. The following describes various aspects related in this application.

According to a first aspect, a wireless communication method is provided, including: sending, by a first node, first sensing assistance information corresponding to a first sensing node; where the first sensing assistance information includes one or more of the following information of the first sensing node: sensing capability information, operating bandwidth information, sensing precision information, transmit power information, electric quantity information, resource occupancy information, indication information of expecting or not expecting to participate in sensing, location information, or information for matching with sensed targets.

According to a second aspect, a wireless communication device is provided, where the communication device is a first node. The communication device includes: at least one processor, and at least one memory including computer program, wherein the at least one memory and the at least one processor are configured with the computer program, to cause the wireless communication device at least to send first sensing assistance information corresponding to a first sensing node; where the first sensing assistance information includes one or more of the following information of the first sensing node: sensing capability information, operating bandwidth information, sensing precision information, transmit power information, electric quantity information, resource occupancy information, indication information of expecting or not expecting to participate in sensing, location information, or information for matching with sensed targets.

According to a third aspect, a wireless communication device is provided, where the communication device is a sensing control node. The communication device includes: at least one processor, and at least one memory including computer program, wherein the at least one memory and the at least one processor are configured with the computer program, to cause the wireless communication device at least to receive first sensing assistance information corresponding to a first sensing node and sent by a first node; where the first sensing assistance information includes one or more of the following information of the first sensing node: sensing capability information, operating bandwidth information, sensing precision information, transmit power information, electric quantity information, resource occupancy information, indication information of expecting or not expecting to participate in sensing, location information, or information for matching with sensed targets.

### BRIEF DESCRIPTION OF DRAWINGS

FIG. 1 shows a wireless communication system to which an embodiment of this application is applied.

FIG. 2 is a schematic diagram of eight sensing modes.

FIG. 3 is a schematic diagram of a scenario in which a plurality of nodes participate in sensing.

FIG. 4 is a schematic flowchart of a wireless communication method according to an embodiment of this application.

FIG. 5 is a schematic flowchart of a wireless communication method according to Embodiment 1 of this application.

FIG. 6 is a schematic flowchart of a wireless communication method according to Embodiment 2 of this application.

FIG. 7 is a schematic flowchart of a wireless communication method according to Embodiment 3 of this application.

FIG. 8 is a schematic flowchart of a wireless communication method according to Embodiment 4 of this application.

FIG. 9 is a schematic flowchart of a wireless communication method according to Embodiment 5 of this application.

FIG. 10 is a schematic flowchart of a possible implementation of S920 according to Embodiment 5.

FIG. 11 is a schematic flowchart of a possible implementation of S920 according to Embodiment 5.

FIG. 12 is a schematic flowchart of a wireless communication method according to Embodiment 6 of this application.

FIG. 13 is a schematic flowchart of a wireless communication method according to Embodiment 7 of this application.

FIG. 14 is a schematic flowchart of a wireless communication method according to Embodiment 8 of this application.

FIG. 15 is a schematic diagram of a structure of a communication device according to an embodiment of this application.

FIG. 16 is a schematic diagram of a structure of another communication device according to an embodiment of this application.

FIG. 17 is a schematic diagram of a structure of an apparatus according to an embodiment of this application.

### DESCRIPTION OF EMBODIMENTS

The following describes technical solutions in this application with reference to the accompanying drawings.

### Communication Network

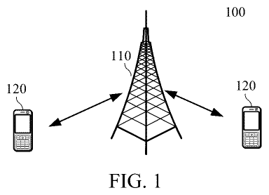

FIG. 1 shows a wireless communication system 100 to which an embodiment of this application is applied. The wireless communication system 100 may include one or more communication devices, and the communication device may be, for example, a network device 110 or a terminal device 120. The network device 110 may be a device in communication with the terminal device 120. Each network device 110 may provide communication coverage for a specific geographic area, and may communicate with a terminal device 120 located within the coverage area.

FIG. 1 exemplarily shows one network device and two terminal devices. Optionally, the wireless communication system 100 may include a plurality of network devices, and another quantity of terminal devices may be included in the coverage of each network device, which is not limited in this embodiment of this application.

Optionally, the wireless communication system 100 may further include other network entities such as a network controller and a mobility management entity, which is not limited in this embodiment of this application.

It should be understood that technical solutions of embodiments of this application may be applied to various communication systems, such as a 5^{th} generation (5G) system or a new radio (NR) system, a long term evolution (long term evolution, LTE) system, an LTE frequency division duplex (FDD) system, and an LTE time division duplex (TDD) system. The technical solutions provided in this application may be further applied to a future communication system, such as a 6^{th} generation mobile communication system and a communication system of a subsequent version, or a satellite communication system.

The terminal device in embodiments of this application may also be referred to as user equipment (UE), an access terminal, a subscriber unit, a subscriber station, a mobile site, a mobile station (MS), a mobile terminal (MT), a remote station, a remote terminal, a mobile device, a user terminal, a terminal, a wireless communication device, a user agent, or a user apparatus. The terminal device in embodiments of this application may be a device providing a user with voice and/or data connectivity and capable of connecting people, objects, and machines, such as a handheld device or vehicle-mounted device having a wireless connection function. The terminal device in embodiments of this application may be a mobile phone, a tablet computer (pad), a notebook computer, a palmtop computer, a mobile Internet device (MID), a wearable device, a virtual reality (VR) device, an augmented reality (AR) device, a wireless terminal in industrial control, a wireless terminal in self driving, a wireless terminal in remote medical surgery, a wireless terminal in a smart grid, a wireless terminal in transportation safety, a wireless terminal in a smart city, a wireless terminal in a smart home, or the like. Optionally, the UE may be used to function as a base station. For example, a UE may act as a scheduling entity, which provides sidelink signals between UEs in vehicle to everything (V2X) or device-to-device (D2D) communication, or the like. For example, a cellular phone and a vehicle communicate with each other by using a sidelink signal. A cellular phone and a smart household device communicate with each other, without the relay of a communication signal through a base station.

The network device in embodiments of this application may be a device for communicating with the terminal device. The network device may include an access network device and a core network device. The access network device may also be referred to as wireless access network device. The network device in embodiments of this application may be a radio access network (RAN) node (or device) that connects the terminal device to a wireless network. The network device may be a base station. The base station may broadly cover the following various names, or may be interchanged with the following names, such as a NodeB, an evolved NodeB (eNB), a next generation NodeB (gNB), a relay station, an access point, a transmitting and receiving point (TRP), a transmitting point (TP), a master eNode (MeNB), a secondary eNode (SeNB), a multi-standard radio (MSR) node, a home base station, a network controller, an access node, a radio node, an access point (AP), a transmission node, a transceiver node, a baseband unit (BBU), a remote radio unit (RRU), an active antenna unit (AAU), a remote radio head (RRH), a central unit (CU), a distributed unit (DU), a positioning node, and the like. The base station may be a macro base station, a micro base station, a relay node, a donor node, or the like, or a combination thereof. Alternatively, the base station may be a communication module, a modem, or a chip disposed in the device or apparatus described above. Alternatively, the base station may be a mobile switching center, a device that assumes the function of a base station in D2D, V2X, and machine-to-machine (M2M) communications, a network-side device in a 6G network, a device that assumes the function of a base station in a future communication system, or the like. The base station may support networks with a same access technology or different access technologies. A specific technology and a specific device form used by the network device are not limited in embodiments of this application.

The base station may be a fixed or mobile base station. For example, a helicopter or an unmanned aerial vehicle may be configured to function as a mobile base station, and one or more cells may move according to a position of the mobile base station. In another example, a helicopter or an unmanned aerial vehicle may be configured to serve as a device in communication with another base station.

In some deployments, the network device in embodiments of this application may be a CU or a DU, or the network device includes a CU and a DU. The gNB may further include an AAU.

The network device and the terminal device may be deployed on land, including being indoors or outdoors, handheld, or in-vehicle, may be deployed on a water surface, or may be deployed on a plane, a balloon, or a satellite in the air. In embodiments of this application, a scenario where the network device and the terminal device are located is not limited.

It should be understood that all or some of the functions of the communications device in this application may also be implemented by software functions running on hardware, or by virtualization functions instantiated on a platform (such as a cloud platform).

### Sensing Network

In a narrow sense, a sensing network may refer to a system with capabilities such as object positioning, object imaging, object detection, object tracking, and object recognition. The object positioning may include one or more of the following sensing operations on a sensed target: ranging, speed measurement, or angle measurement.

In a broad sense, a sensing network may refer to a system being aware of attributes and states of any service, network, user, terminal, and environmental object.

From the perspective of sensing application, sensing may be classified into the following categories: outdoor/wide area/local area applications and indoor/local area applications.

The outdoor/wide area/local area applications may include one or more of the following applications: smart city, smart transportation/high-speed rail, low-altitude applications, or the like. The smart city may include, for example, weather monitoring. The smart transportation/high-speed rail may include, for example, one or more of the following: high-precision map construction, road monitoring and management, intrusion detection, or the like. The low-altitude application may include, for example, one or more of: unmanned aerial vehicle monitoring, unmanned aerial vehicle obstacle avoidance, flight intrusion detection, flight path management, or the like.

The indoor/local area applications may include one or more of the following applications: smart home, health management, smart factory, or the like. The health management may include, for example, one or more of respiratory monitoring, intrusion detection, gesture/posture recognition, motion monitoring, movement tracking, or the like. The smart factory may include, for example, one or more of intrusion detection, material detection, product defect detection, or the like.

It should be noted that the foregoing sensing applications and classification of sensing applications are used as examples, and an application scope of sensing is not limited thereto.

### Integrated Sensing and Communication

Sensing is an important application of modern radio frequency technologies. Sensing may be achieved by using a radio wave. For example, a sensing technology may use a radio wave to detect a parameter of a physical environment, to achieve environmental sensing such as object positioning, motion recognition, and imaging. Another important application of modem radio frequency technologies is wireless communication. Independent existence of sensing and wireless communication, namely, separate design, causes waste of wireless spectra and hardware resources.

With development of technologies, in some networks (such as 6G or beyond 5G (B5G) networks), communication can be implemented via communication spectrum based on millimeter waves, terahertz waves, visible light, and the like. That is, a spectrum of wireless communication may overlap with a sensing spectrum. A next generation network (such as a 6G network) may be a fusion of at least two of a mobile communication network, a sensing network, and a computing power network.

A communication-sensing integration technology may be used to integrate wireless communication and sensing. The communication-sensing integration technology may achieve many functions. For example, based on the communication-sensing integration technology, wireless resources of wireless communication may be utilized to implement a sensing function. For another example, widely deployed cellular networks may be utilized to implement sensing services over a larger area. For another example, a network device and a plurality of terminal devices may be utilized for joint sensing to achieve higher sensing precision. For another example, a hardware module for wireless communication may be reused to achieve the sensing function and reduce costs.

It may be understood that the communication-sensing integration technology may enable a wireless communication system to have sensing capabilities, providing a foundation for development of smart transportation, smart city, smart factory, unmanned aerial vehicle, and other services.

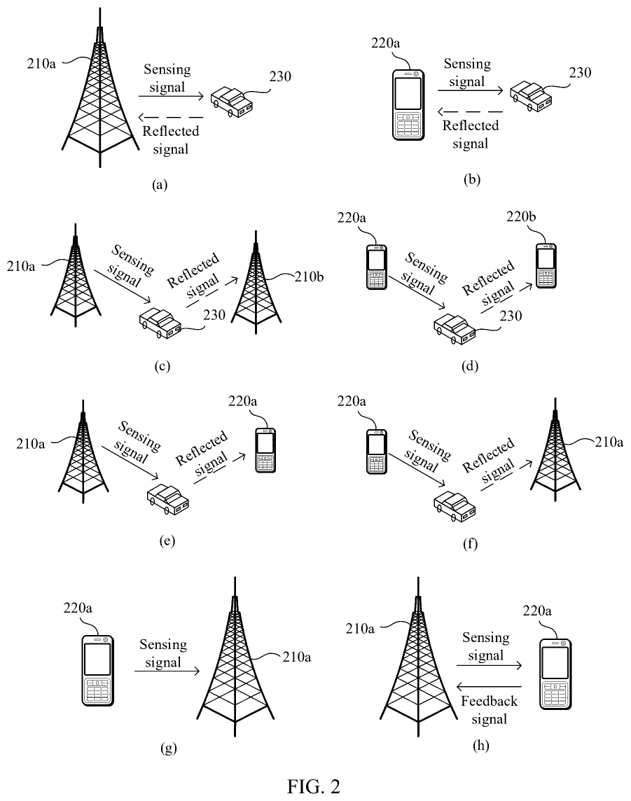

Sensing may be achieved through different modes. FIG. 2 is a schematic diagram of eight sensing modes.

(a) in FIG. 2 is a schematic diagram of mode 1. In mode 1, a network device performs sensing through self-sending and self-receiving. As shown in (a) in FIG. 2, a node for sending a signal/channel used for sensing (referred to as a sensing signal/channel below) is a network device 210a (for example, a gNB). After the network device 210a sends a sensing signal, the sensing signal is reflected by a sensed target 230 (for example, the vehicle shown in (a) in FIG. 2), and a reflected signal returns to the network device 210a (it may also be considered that the sensing signal returns to the network device 210a). The network device 210a is not only a node for sending a sensing signal/channel but also a node for receiving a sensing signal/channel. The signal/channel described in embodiments of this application may also be referred to as channel/signal.

(b) in FIG. 2 is a schematic diagram of mode 2. In mode 2, a terminal device performs sensing through self-sending and self-receiving. As shown in (b) in FIG. 2, a node for sending a sensing signal/channel is a terminal device 220a. After the terminal device 220a sends a sensing signal, the sensing signal is reflected by a sensed target 230 (for example, the vehicle shown in (b) in FIG. 2), and a reflected signal returns to the terminal device 220a (it may also be considered that the sensing signal returns to the terminal device 220a). The terminal device 220a is not only a node for sending a sensing signal/channel but also a node for receiving a sensing signal/channel.

(c) in FIG. 2 is a schematic diagram of mode 3. In mode 3, network devices collaborate on sensing. As shown in (c) in FIG. 2, a node for sending a sensing signal/channel is a network device 210a (for example, a gNB). After the network device 210a sends a sensing signal, the sensing signal is reflected by a sensed target 230 (for example, the vehicle shown in (c) in FIG. 2), and a reflected signal is transmitted to another network device 210b (it may also be considered that the sensing signal is transmitted to another network device 210b). The network device 210b is a node for receiving a sensing signal/channel.

(d) in FIG. 2 is a schematic diagram of mode 4. In mode 4, terminal devices collaborate on sensing. As shown in (d) in FIG. 2, a node for sending a sensing signal/channel is a terminal device 220a. After the terminal device 220a sends a sensing signal, the sensing signal is reflected by a sensed target 230 (for example, the vehicle shown in (d) in FIG. 2), and a reflected signal is transmitted to another terminal device 220b (it may also be considered that the sensing signal is transmitted to the terminal device 220b). The terminal device 220b is a node for receiving a sensing signal/channel.

(e) in FIG. 2 is a schematic diagram of mode 5. In mode 5, a network device and a terminal device collaborate on sensing. A node for sending a sensing signal/channel is a network device 210a (for example, a gNB). After the network device 210a sends a sensing signal, the sensing signal is reflected by a sensed target 230 (for example, the vehicle shown in (e) in FIG. 2), and a reflected signal is transmitted to a terminal device 220a (it may also be considered that the sensing signal is transmitted to the terminal device 220a). The terminal device 220a is a node for receiving a sensing signal/channel.

(f) in FIG. 2 is a schematic diagram of mode 6. In mode 6, a terminal device and a network device collaborate on sensing. A node for sending a sensing signal/channel is a terminal device 220a. After the terminal device 220a sends a sensing signal, the sensing signal is reflected by a sensed target 230 (for example, the vehicle shown in (f) in FIG. 2), and a reflected signal is transmitted to a network device 210a (it may also be considered that the sensing signal is transmitted to the network device 210a). The network device 210a is a node for receiving a sensing signal/channel.

(g) in FIG. 2 is a schematic diagram of mode 7. In mode 7, a sensed target is a node for sending a sensing signal/channel. For example, a terminal device 220a, as a sensed target, sends a sensing signal to a network device 210a (for example, a gNB), and the network device 210a receives the sensing signal and senses the terminal device 220a.

(h) in FIG. 2 is a schematic diagram of mode 8. In mode 8, a sensed target is a node for receiving a sensing signal/channel. For example, a network device 210a (for example, a gNB) sends a sensing signal, and a terminal device 220a is a node for receiving a sensing signal/channel. After receiving the sensing signal, the terminal device 220a sends a feedback signal (feedback) to the network device 210a.

In some cases, some problems arise in a communication-sensing integrated system.

In some cases, a quantity of nodes participating in sensing may be relatively small. For example, in example scenarios of the eight sensing modes shown in FIG. 2, there may be only a single sensing node or a pair of sensing nodes in a sensing process. In a wireless communication system, there are a huge quantity of terminal devices. When there are a plurality of nodes with sensing capabilities (such as network devices or terminal devices that can send and/or receive sensing signals) around a sensed target, the plurality of nodes may participate in sensing together. When there are a plurality of nodes in the system, the entire sensing service may need to be controlled and managed (which may be achieved, for example, through a sensing control node).

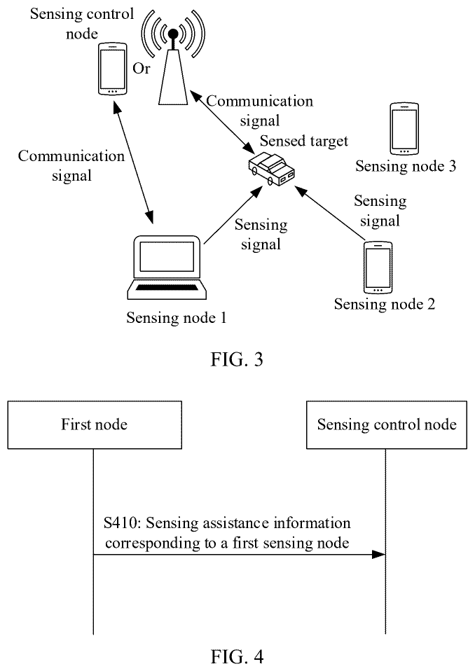

FIG. 3 is a schematic diagram of a scenario in which a plurality of nodes participate in sensing. The scenario shown in FIG. 3 may include sensing node 1, sensing node 2, sensing node 3, a sensing control node, and a sensed target. The sensing control node may communicate with some or all of the sensing nodes. For example, the sensing control node may communicate with sensing node 1 and/or the sensed target by using communication signals. Sensing node 1, sensing node 2, and sensing node 3 are all located around the sensed target. In some cases, sensing node 1, sensing node 2, and sensing node 3 may all sense the sensed target. In some cases, a sensing node participating in sensing the sensed target may be managed and/or selected by the sensing control node. For example, as shown in FIG. 3, the sensing control node may select sensing node 1 and/or sensing node 2 to sense the sensed target. In other words, sensing node 1 and/or sensing node 2 may transmit sensing signals to the sensed target, thereby achieving sensing of the sensed target. In other words, in the scenario shown in FIG. 3, there may be three nodes (sensing node 1, sensing node 2, and sensing node 3), and the sensing control node may manage sensing node 1 and sensing node 2 to server as nodes currently participating in sensing the sensed target.

An increase in a quantity of nodes participating in sensing causes many problems. For example, nodes around the sensed target may not each be suitable nodes for participating in sensing. Some nodes may have no sensing capability and therefore cannot participate in sensing. Some nodes may be far away from the sensed target and therefore contribute less to sensing. For another example, although some nodes have a capability of sensing, they do not expect to participate in sensing (for example, they do not expect to sense a specific sensed target and/or sensed service). If the nodes described above are selected to participate in sensing the sensed target and/or the sensed service, problems such as low sensing efficiency and insufficient sensing precision may occur.

FIG. 4 is a schematic flowchart of a wireless communication method according to an embodiment of this application, to resolve the foregoing problems. The method shown in FIG. 4 may be implemented by a first node and/or a sensing control node.

The first node may be a sensing node or a sensed target.

The sensing node may be a node for receiving and/or sending a sensing signal/channel. The node for receiving a sensing signal/channel and the node for sending a sensing signal/channel may be a same entity. For example, the sensing node may be the network device in mode 1 or the terminal device in mode 2 described above. A sensing scenario or a sensing system may include one or more sensing nodes, and the one sensing node or the plurality of sensing nodes may include a first sensing node. The first node may be, for example, the first sensing node.

The sensed target may be an object required to be sensed by one or more sensing nodes. In some embodiments, the sensed target may also be referred to as a sensed node or a sensed object. A type of sensing performed on the sensed target is not limited in this application. For example, one or more of positioning, imaging, detection, tracking, and identification may be performed on the sensed target.

The sensing control node can control and manage a sensing service. For example, the sensing control node may be used to select a sensing node for a sensed target and/or a sensed service. In some embodiments, the sensing control node may implement one or more of the following functions: managing a sensing service, sending configuration information to a sensing node and/or a sensed target, configuring sending and/or receiving of a sensing/measurement signal, sending and/or receiving of a sensing signal, configuring a sensing node and/or a sensed target to report a measurement result and/or a sensing result, or the like.

The sensing control node may be any node in a sensing scenario or a sensing system. For example, the sensing control node and the sensing node and/or sensed target may be a same entity. Alternatively, the sensing control node may be a separate entity. A type of the sensing control node is not limited in this application. For example, the sensing control node may be a communication device such as a terminal device or a network device (for example, an access network device or a core network device).

It may be understood that the first node may be a communication device such as a terminal device or a network device.

The method shown in FIG. 4 may include S410.

S410: The first node may send first sensing assistance information corresponding to the first sensing node. The sensing control node may receive the first sensing assistance information corresponding to the first sensing node.

It may be understood that the first node may send the first sensing assistance information to the sensing control node. For example, the first node may directly send the first sensing assistance information to the sensing control node. Alternatively, the first node may forward the first sensing assistance information to the sensing control node through another node. In some embodiments, the first node may send the first sensing assistance information to the sensing control node through a sensed target. The sensing control node may receive, through the sensed target, the first sensing assistance information sent by the first node.

The first sensing node may be any sensing node. The first sensing assistance information corresponding to the first sensing node may include one or more of the following information of the first sensing node: sensing capability information, operating bandwidth information, sensing precision information, transmit power, electric quantity information, resource occupancy information, indication information of expecting or not expecting to participate in sensing, location information, or information for matching with sensed targets.

Another node can obtain, through the first sensing assistance information corresponding to the first sensing node, sensing related information of the first sensing node, to perform operations such as configuration and management for information, a service, transmission, or the like related to the first sensing node, so that a communication sensing integrated system can operate accurately and efficiently. For example, the sensing control node may determine, based on first sensing assistance information corresponding to one or more sensing nodes, a sensing node participating in sensing the sensed target. The first sensing node is used as an example. The sensing control node may determine, based on the first sensing assistance information corresponding to the first sensing node, whether to participate in sensing the sensed target by the first sensing node.

The following describes content that may be included in the first sensing assistance information:
(1) The sensing capability information may be used to indicate a sensing capability of the first sensing node. The sensing capability may include one or more of the following capabilities: a capability of sending a sensing signal; a capability of receiving a sensing signal; or a capability of processing a sensing signal.

In an implementation, the sensing capability information may include but is not limited to sensing capability indication information and/or a sensing capability level.

The sensing capability indication information may be used to indicate whether the first sensing node has a sensing capability. For example, the sensing capability indication information may be represented by a first bit. The first bit being 0 may indicate that the first sensing node does not have the sensing capability. The first bit being 1 may indicate that the first sensing node has the sensing capability. Alternatively, the first bit being 0 may indicate that the first sensing node has the sensing capability, and the first bit being 1 may indicate that the first sensing node does not have the sensing capability. It should be noted that the first bit may be used to indicate a part or all of sensing capabilities of the first sensing node. For example, the first bit may be used to indicate all of the capability of sending a sensing signal, the capability of receiving a sensing signal, and the capability of processing a sensing signal. Alternatively, the first bit may be used to indicate whether the first sensing node has the capability of sending a sensing signal. It can be understood that the sensing capability indication information may be further represented by a second bit and/or a third bit. For example, the first bit may be used to indicate whether the first sensing node has the capability of sending a sensing signal, the second bit may be used to indicate whether the first sensing node has the capability of receiving a sensing signal, and the third bit may be used to indicate whether the first sensing node has the capability of processing a sensing signal.

The sensing capability level may be used to indicate a level of a sensing capability of the first sensing node. The sensing capability may be, for example, divided into a plurality of capability levels. The capability levels may include levels 1 to N. The first sensing node may have any level from 1 to N. Herein, N may be an integer greater than 1. A higher capability level may indicate a higher sensing capability of the first sensing node.

It can be understood that a node with a higher sensing capability is more suitable for providing a sensing service. A sensing node may be selected from a plurality of sensing nodes based on the sensing capability information, to sense the sensed target. For example, the sensing control node may select a node with a higher capability to sense the sensed target.

(2) The operating bandwidth information may be used to indicate a bandwidth associated with the first sensing node. The operating bandwidth information may include one or more of the following information: an operating bandwidth of the first sensing node, or a bandwidth of a sensing signal transmitted by the first sensing node. The bandwidth may include, for example, one or more of an uplink bandwidth, a downlink bandwidth, or a sidelink (SL) bandwidth.

The bandwidth may include, for example, a maximum bandwidth. In other words, the operating bandwidth information may be used to indicate a maximum bandwidth associated with the first sensing node.

It can be understood that a node with a larger bandwidth is more suitable for providing a sensing service. Therefore, a sensing node may be selected from a plurality of sensing nodes based on the operating bandwidth information to sense the sensed target. For example, the sensing control node may select a sensing node with a larger operating bandwidth and/or a larger bandwidth of a transmitted sensing signal to sense the sensed target.

(3) The sensing precision information may be used to indicate precision information related to sensing. For example, the sensing precision information may include one or more of measurement precision, measurement result quantification precision, or antenna information.

The measurement precision may also be referred to as measurement resolution or sensing precision. The measurement result quantification precision may also be referred to as quantization resolution of a measurement result or quantization precision of a sensing result. The precision may include, for example, one or more of time resolution, angle resolution, position resolution, or velocity resolution. It can be understood that a smaller resolution indicates a higher sensing precision.

The antenna information may include, for example, a quantity of antennas and/or a quantity of antenna arrays. It can be understood that a larger quantity of antennas and/or antenna arrays indicates a higher precision.

It can be understood that a node with a higher sensing precision is more suitable for providing a sensing service. Therefore, a sensing node may be selected from a plurality of sensing nodes based on the sensing precision information to sense the sensed target. For example, the sensing control node may select a sensing node with a higher sensing precision to sense the sensed target.

(4) The transmit power information may be used to indicate a transmit power of the first sensing node. The transmit power may include, for example, a maximum transmit power. It can be understood that a transmit power of a node may affect a coverage range of sensing performed by the node. In other words, a larger transmit power of the first sensing node indicates a larger coverage range of sensing performed by the first sensing node. In some implementations, a sensing node with a larger transmit power may be selected to sense the sensed target.

(5) The electric quantity information may be used to indicate electric quantity related information of the first sensing node. For example, the electric quantity information may include one or more of a current remaining power, or an estimated remaining operating time corresponding to a remaining power. In some implementations, a sensing node with more remaining power may be selected to sense the sensed target.

(6) The resource occupancy information may be used to indicate resource information related to the first sensing node. The resource may be, for example, a wireless resource. For example, the resource occupancy information may include one or more of the following information: traffic information, channel state information of a link associated with the first sensing node, or time-frequency resource information.

The traffic information may include one or more of the following information: uplink traffic information, downlink traffic information, or sidelink traffic information.

The channel state information of the link related to the first sensing node may include information about one or more of the following links: a link between the first sensing node and a sensed target, a link between the first sensing node and a sensing sending node, a link between the first sensing node and a sensing receiving node, a link between the first sensing node and a sensing control node, and a link between the first sensing node and an access network device. In a case that the first sensing node is a sensing receiving node, the link related to the first sensing node may include a link between the first sensing node and a sensing sending node. In a case that the first sensing node is a sensing sending node, the link related to the first sensing node may include a link between the first sensing node and a sensing receiving node.

The resource occupancy information may be used, for example, to indicate a resource occupancy status of the first sensing node over a period of time. The period of time may include a period of time in the past, and/or a period of time in the future. It can be understood that, in a case that the period of time includes a period of time in the past, the resource occupancy information may be used to indicate a status of resources occupied in a period of time in the past. In a case that the period of time includes a period of time in the future, the resource occupancy information may be used to indicate a status of resources that are expected to be and/or can be occupied in a period of time in the future.

The time-frequency resource information may include one or more of the following time-frequency resource information: uplink resource information, downlink resource information, or sidelink resource information.

It can be understood that a node with more abundant resources is more suitable for providing a sensing service. Therefore, a sensing node may be selected from a plurality of sensing nodes based on the resource occupancy information to sense the sensed target. For example, the sensing control node may select a sensing node available for sensing to sense the sensed target.

(7) The indication information of expecting or not expecting to participate in sensing may be used to indicate whether the first sensing node expects to participate in the sensing. For example, the indication information of expecting or not expecting to participate in sensing includes one or more of the following: indication information of expecting or not expecting to participate in sending a sensing signal; indication information of expecting or not expecting to participate in receiving a sensing signal; information about a sensed target expected or not expected for participating in sensing; or information about a sensing service expected or not expected for participating in sensing.

(8) The location information may be used to indicate a location of the first sensing node. The location of the first sensing node may include an absolute location and/or a relative location of the first sensing node. The relative location may be, for example, a location of the first sensing node relative to a specific node. For example, the relative location may be a location of the first sensing node relative to a sensed target.

Indication precision of the location information is not limited in this application. For example, the location information may include rough location information. The rough location information may include range information. For example, the rough location information may include one or more of the following: the first sensing node is within a specific range, a distance of the first sensing node relative to the sensed target is within a specific distance range, or an angle of the first sensing node relative to the sensed target is within a specific angle range.

The location information may also be used to indicate an identifier related to the location of the first sensing node. The identifier related to the location may include, for example, a room identifier, a street identifier, a community identifier, a geographic range identifier, and the like.

It can be understood that a node closer to the sensed target is more suitable for providing a sensing service. Therefore, a sensing node may be selected from a plurality of sensing nodes based on the location information to participate in sensing the sensed target. For example, the sensing control node may select a node closer to the sensed target to sense the sensed target.

(9) The information for matching with sensed targets may be used to indicate a matching status for the sensed target. For example, the information for matching with sensed targets may include one or more of the following: a sensing service list, a sensing node list, or a sensed target list.

The sensing service list may include one or more of the following lists for the first sensing node: a list of services expected for sensing, a list of services capable of being sensed, a list of services allowed to be sensed, a list of services not expected for sensing, a list of services incapable of being sensed, or a list of services not allowed to be sensed. It can be understood that, for the list of services expected for sensing, the first sensing node expects to sense any service in the list. For the list of services capable of being sensed, the first sensing node is capable of sensing any service in the list. For the list of services allowed to be sensed, the first sensing node is allowed to sense any service in the list. For the list of services not expected for sensing, the first sensing node does not expect to sense any service in the list. For the list of services incapable of being sensed, the first sensing node is incapable of sensing any service in the list. For the list of services not allowed to be sensed, the first sensing node is not allowed to sense any service in the list.

The sensing node list may include one or more of the following lists for a sensed target: a first list, a second list, a third list, a fourth list, a fifth list, or a sixth list. The sensed target expects to be sensed by any sensing node in the first list, the sensed target is capable of being sensed by any sensing node in the second list, the sensed target is allowed to be sensed by any sensing node in the third list, the sensed target does not expect to be sensed by any sensing node in the fourth list, the sensed target is incapable of being sensed by any sensing node in the fifth list, and the sensed target is not allowed to be sensed by any sensing node in the sixth list.

In some embodiments, in a case that the first node is a sensed target, the information for matching with sensed targets may include the sensing node list.

The sensed target list may include one or more of the following lists for the first sensing node: a list of sensed targets expected for sensing, a list of sensed targets capable of being sensed, a list of sensed targets allowed to be sensed, a list of sensed targets not expected for sensing, a list of sensed targets incapable of being sensed, or a list of sensed targets not allowed to be sensed. For the list of sensed targets expected for sensing, the first sensing node expects to sense any sensed target in the list. For the list of sensed targets capable of being sensed, the first sensing node is capable of sensing any sensed target in the list. For the list of sensed targets allowed to be sensed, the first sensing node is allowed to sense any sensed target in the list. For the list of sensed targets not expected for sensing, the first sensing node does not expect to sense any sensed target in the list. For the list of sensed targets incapable of being sensed, the first sensing node is incapable of sensing any sensed target in the list. For the list of sensed targets not allowed to be sensed, the first sensing node is not allowed to sense any sensed target in the list.

In some embodiments, the information for matching with sensed targets may be in terms of sensing services. In other words, for each sensing service, corresponding information for matching with sensed targets may be configured. Alternatively, the information for matching with sensed targets may be in terms of sensing nodes. In other words, for each sensing node, corresponding information for matching with sensed targets may be configured. Alternatively, the information for matching with sensed targets may be in terms of sensed targets. In other words, for each sensed target, corresponding adaptation information for the sensed target may be configured. Alternatively, the information for matching with sensed targets may be in terms of combinations of sensing services, sensing nodes, and sensed targets.

It should be noted that a part or all of the content in the foregoing first sensing assistance information may be configured to be mandatory or optional. For example, the sensing capability information may be mandatory and other information may be optional. Optional content may be included or not included in the first sensing assistance information. In a case that the first sensing assistance information does not include the content, a value of the content may be a default value or left blank. Mandatory content is required to be included or must be included in the first sensing assistance information.

The first sensing assistance information may be transmitted based on configuration information. In some embodiments, the first node may send the first sensing assistance information based on the configuration information. Accordingly, the sensing control node may receive the first sensing assistance information based on the configuration information.

It should be noted that the first node may directly send the first sensing assistance information without relying on the configuration information. The sensing control node may directly receive the first sensing assistance information without relying on the configuration information.

In some embodiments, a part or all of the configuration information may be received by the first node. For example, a part or all of the configuration information may be sent by the sensing control node to the first node. In other words, a part or all of the configuration information may be configured by the sensing control node for the first node. In some embodiments, a part or all of the configuration information may be protocol-specified.

In some embodiments, the configuration information may be used to configure one or more of the following: content included in the first sensing assistance information, resource information used for transmission of the first sensing assistance information, an identifier of the first sensing node, or a type of the first sensing node.

The content included in the first sensing assistance information may include one or more of the items described above. That is, the content included in the first sensing assistance information may include one or more of sensing capability information, operating bandwidth information, sensing precision information, transmit power information, electric quantity information, resource occupancy information, indication information of expecting or not expecting to participate in sensing, location information, or information for matching with sensed targets. Actual content included in the first sensing assistance information may be configured by using the configuration information.

The resource information used for transmission of the first sensing assistance information may include one or more of the following: a transmission cut-off time of the first sensing assistance information, information about a time unit occupied by the first sensing assistance information, or a frequency domain resource occupied by the first sensing assistance information.

The transmission cut-off time may be used to indicate that the first sensing assistance information is sent no later than a first time. It can be understood that “no later than” may include earlier than or equal to. The first time may be directly or indirectly indicated by the transmission cut-off time. For example, the first time may be calculated based on the transmission cut-off time. The first time may be an absolute time or a relative time. That is, the first time may include a first absolute time and/or a first relative time.

In an implementation, the transmission cut-off time may include a first time unit and/or a first time length.

The first time unit may be used to indicate that the first sensing assistance information is sent no later than the first time unit. It can be understood that “no later than” may include earlier than or equal to. It can be understood that the first time unit may be an absolute time. For example, the first time unit may include a specific subframe, a specific frame, a specific slot, a specific subslot, a specific symbol, or a specific symbol set.

The first time length may be used to indicate that the first sensing assistance information is sent no later than a second time unit. It can be understood that “no later than” may include earlier than or equal to. The second time unit may be determined based on the first time length and a first reference time unit. The first reference time unit may be a time unit occupied by the configuration information. For example, the first reference time unit may be a 1^{st} time unit occupied by the configuration information. Alternatively, the first reference time unit may be a last time unit occupied by the configuration information. In an implementation, the second time unit may be a time unit that is later than the first reference time unit by the first time length. Alternatively, the second time unit may be any time unit after a time staring from the first reference time unit and lasting for the first time length elapses. In other words, the second time unit may be a time unit that is subsequent to the first reference time unit and is separated from the first reference time unit by at least the first time length, that is, an interval between the second time unit and the first reference time unit may be greater than or equal to the first time length.

The information about a time unit occupied by the first sensing assistance information may be used to indicate in which time unit or time units the first sensing assistance information is transmitted. For example, the information about a time unit occupied by the first sensing assistance information may be used to indicate a 1^{st} time unit and/or a last time unit occupied by the first sensing assistance information.

In some embodiments, the information about a time unit occupied by the first sensing assistance information may include a number of an absolute time unit occupied by the first sensing assistance information. For example, the number of the absolute time unit may include one or more of a subframe number, a frame number, a slot number, a subslot number, a symbol number, or a symbol set number.

In some embodiments, there is a time offset between a time unit occupied by the first sensing assistance information and the time unit occupied by the configuration information. For example, the information about a time unit may include: a time offset between the time unit occupied by the first sensing assistance information and the time unit occupied by the configuration information (for example, the 1^{st} or last time unit occupied by the configuration information) is equal to m time units. If the configuration information is received at time unit n, the first node may transmit the first sensing assistance information at time unit n+m. Herein, m may be an integer greater than or equal to 0.

The frequency domain resource occupied by the first sensing assistance information may be explicitly indicated by the configuration information. Alternatively, the frequency domain resource may be implicitly indicated by the configuration information. In an implementation, the frequency resource occupied by the first sensing assistance information is determined based on a time domain resource and/or a frequency domain resource occupied by the configuration information. For example, there may be a many-to-one or one-to-one mapping relationship between the time domain resource and/or the frequency domain resource occupied by the configuration information and the frequency domain resource occupied by the first sensing assistance information. The mapping relationship may be agreed upon by a protocol, or may be configured or indicated by the configuration information.

The identifier of the first sensing node may include an absolute identifier of the first sensing node and/or a relative identifier of the first sensing node. For example, the absolute identifier may include a globally unified absolute identifier of the first sensing node. The relative identifier may be an identifier within a specific geographical range. Within a specific geographical range, a relative identifier of a node is unique.

The type of the first sensing node may include a terminal device or a network device. The terminal device may include any terminal device described above. For example, the terminal device may include a mobile phone or an industrial internet of things (IIoT) device. The network device may include any network device described above. For example, the network device may include an access network device or a core network device.

It is noted herein that the type of the first node is not limited in this application. For example, the first node may be the first sensing node or a sensed target.

In a case that the first node is a sensed target, the first node may receive pieces of first sensing assistance information respectively corresponding to one or more sensing nodes. The pieces of first sensing assistance information may be in a one-to-one correspondence with the one or more sensing nodes. For content of the first sensing assistance information respectively corresponding to the nodes, reference may be made to the first sensing assistance information corresponding to the first sensing node described above.

It can be understood that the first node may receive and send the pieces of first sensing assistance information respectively corresponding to the one or more sensing nodes. In some embodiments, the first node may perform a first operation on the received first sensing assistance information before sending the first sensing assistance information. The first operation may include, for example, performing one or more of the following operations on the content of the first sensing assistance information: filtering, sorting, compressing, or the like.

In a case that the first node receives pieces of first sensing assistance information respectively corresponding to a plurality of sensing nodes, the first node may transmit the pieces of received first sensing assistance information respectively corresponding to the plurality of sensing nodes through combined transmission, separate transmission, or transmission in groups. The combined transmission may be that the pieces of first sensing assistance information respectively corresponding to the plurality of sensing nodes are transmitted by the first node through a same resource or channel. The separate transmission may be that the pieces of first sensing assistance information respectively corresponding to the plurality of sensing nodes are transmitted separately by the first node through independent resources or channels. The transmission in groups may be that the pieces of first sensing assistance information respectively corresponding to the plurality of sensing nodes are grouped into at least one group, and pieces of first sensing assistance information in a same group are transmitted by the first node through a same resource or channel.

It can be understood that, by the solution that the first node receives and forwards pieces of first sensing assistance information respectively corresponding to one or more sensing nodes, resources occupied by sending of the first sensing assistance information can be saved, thereby improving transmission efficiency.

The first node may be a first terminal device or an access network device. The first sensing node may be a second terminal device. The first terminal device may be the same as or different from the second terminal device.

When the first sensing node is the second terminal device, the first sensing assistance information may include uplink information of the second terminal device. The uplink information may include one or more of uplink resource information, uplink channel information, or uplink traffic information, such as an uplink wireless resource occupancy status. Downlink information of the second terminal device may be included in second sensing assistance information corresponding to the first sensing node. The downlink information may include, for example, one or more of downlink resource information, downlink channel information, or downlink traffic information. The second sensing assistance information may be obtained by the access network device. For example, the sensing control node is the access network device, and the access network device may store the second sensing assistance information and obtain the second sensing assistance information by itself. For example, the sensing control node is a core network device, and the access network device may send the obtained second sensing assistance information to the core network device.

It can be understood that the access network device may store content of the second sensing assistance information, so that the access network device may directly obtain the second sensing assistance information. In this case, the first sensing assistance information may not include content included in the second sensing assistance information. Therefore, obtaining and/or transmitting the second sensing assistance information by the access network device can reduce content in the first sensing assistance information, thereby reducing a computing time of each node, and can also reduce transmission resources occupied by the first sensing assistance information, thereby improving efficiency of an entire system.

In some embodiments, in a case that the first node is the first terminal device (the first terminal device and the second terminal device are the same), and the sensing control node may be the access network device, the first terminal device may transmit the first sensing assistance information corresponding to the first sensing node to the access network device, and for the radio resource occupancy status of the first sensing node, the first terminal device may report only an uplink radio resource occupancy status in the first sensing assistance information. The access network device may obtain a downlink wireless resource occupancy status by itself, that is, the access network device may obtain the second sensing assistance information corresponding to the first sensing node by itself.

In some embodiments, the first node may be the first terminal device, and the sensing control node may be the core network device. The first terminal device may directly transmit the first sensing assistance information to the core network device. Alternatively, the first terminal device may transmit the first sensing assistance information to the access network device, and the access network device sends the received first sensing assistance information to the core network device. In an implementation, the first terminal device may transmit the uplink wireless resource occupancy status to the core network device through the first sensing assistance information, and the access network device may obtain the downlink wireless resource occupancy status of the first terminal device by itself, and transmit the downlink wireless resource occupancy status to the core network device through the second sensing assistance information.

In some embodiments, in a case that the first node may be the access network device and the sensing control node is the core network device, the access network device may transmit the first sensing assistance information to the core network device. In a case that the sensed target is a terminal device, the access network device may transmit the second sensing assistance information to the terminal device, and the terminal device may transmit the first sensing assistance information to the core network device. In some embodiments, in a case that the first node may be the first terminal device and the sensing control node is a third terminal device, the first terminal device may send, through a sidelink, the first sensing assistance information corresponding to the first sensing node to the third terminal device.

In a case that the first node is a sensed target, the first node is the first terminal device, and the first sensing node is the second terminal device, the second terminal device may send, through a sidelink, the first sensing assistance information corresponding to the first sensing node to the first terminal device.

In a case that the first node is a sensed target, the first node is the first terminal device, and the first sensing node is the access network device, the access network device may send the first sensing assistance information corresponding to the first sensing node to the first terminal device. In a case that the sensing control node is the core network device, the first terminal device may send the received first sensing assistance information corresponding to the first sensing node to the core network device.

It should be noted that the sensing control node is a sensing node or a sensed target, or a separate node (referred to as separate entity below) other than a sensing node and a sensed target.

In some embodiments, the sensing control node may be a separate entity. After the first node transmits the first sensing assistance information to the sensing control node, the sensing control node may configure or trigger sending and/or receiving of a sensing signal. Alternatively, the sensing control node may trigger measurement.

In some embodiments, the sensing control node may be a sensed target. After the first node transmits the first sensing assistance information to the sensed target, the sensed target may trigger sending and/or receiving of a sensing signal. Alternatively, the sensed target may trigger measurement.

In some embodiments, the sensing control node may be a sensing node. For example, in a case that the first sensing node is a sensing sending node, the sensing control node may be a sensing receiving node. In a case that the first sensing node is a sensing receiving node, the sensing control node may be a sensing sending node. In this case, the first node may transmit the first sensing assistance information to the sensing sending node or the sensing receiving node, and the sensing sending node or the sensing receiving node may trigger sending and/or receiving of a sensing signal. Alternatively, the sensing sending node or the sensing receiving node may trigger measurement.

The following describes, in detail with reference to eight embodiments, execution steps of the communication method provided in this application.

### Embodiment 1

FIG. 5 is a schematic flowchart of a wireless communication method according to Embodiment 1. In FIG. 5, a first node may be a first sensing node. A sensing control node may be a separate entity.

The method shown in FIG. 5 may include S520.

S520: The first sensing node sends first sensing assistance information corresponding to the first sensing node to the sensing control node.

The sensing control node may configure and/or trigger sending and/or receiving of a sensing signal based on the first sensing assistance information. That is, the sensing control node may configure or trigger measurement for a sensed target. The measurement for the sensed target may not be performed by the sensing control node.

Optionally, the method shown in FIG. 5 may further include S510.

S510: The first sensing node receives configuration information sent by the sensing control node. The first sensing node may transmit the first sensing assistance information based on the configuration information.

### Embodiment 2

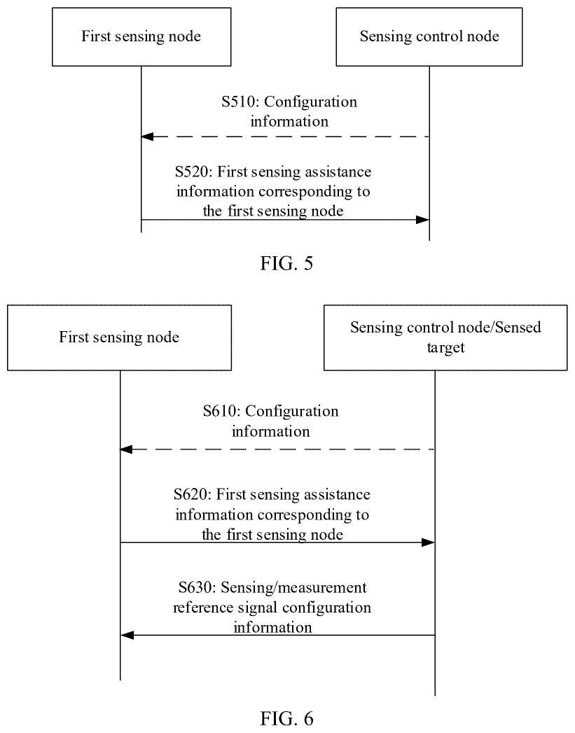

FIG. 6 is a schematic flowchart of a wireless communication method according to Embodiment 2. In FIG. 6, a first node may be a first sensing node. A sensing control node may be a sensed target.

The method shown in FIG. 6 may include S620 and S630.

S620: The first sensing node sends first sensing assistance information corresponding to the first sensing node to the sensed target.

S630: The sensed target may trigger sending and/or receiving of a sensing signal. In some embodiments, the sensed target may send sensing or measurement reference signal configuration information to the first sensing node, to trigger sending and/or receiving of a sensing signal.

Optionally, the method shown in FIG. 6 may further include S610.

S610: The first sensing node receives configuration information sent by the sensed target. The first sensing node may transmit the first sensing assistance information based on the configuration information.

### Embodiment 3

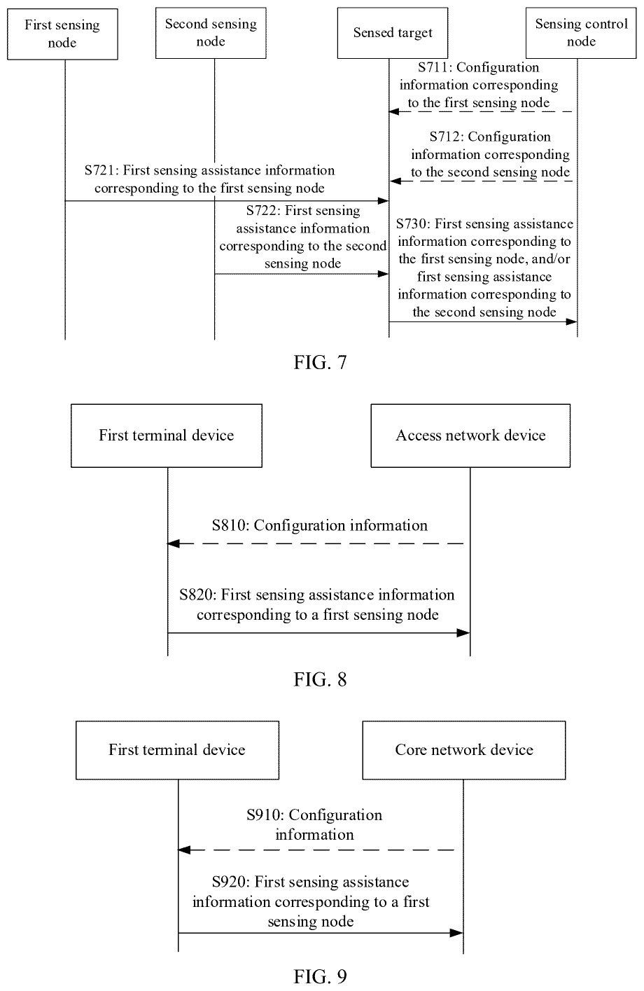

FIG. 7 is a schematic flowchart of a wireless communication method according to Embodiment 3. In FIG. 7, a first node may be a sensed target. A scenario related in the method shown in FIG. 7 may include a plurality of sensing nodes. The plurality of sensing nodes may include a first sensing node and a second sensing node.

The method shown in FIG. 7 may include S721, S722, and S730.

S721: A first sensing node sends first sensing assistance information corresponding to the first sensing node to the sensed target.

S722: A second sensing node sends first sensing assistance information corresponding to the second sensing node to the sensed target.

S730: The sensed target sends the first sensing assistance information corresponding to the first sensing node and/or the first sensing assistance information corresponding to the second sensing node to a sensing control node.

It can be understood that the sensed target may separately transmit the first sensing assistance information corresponding to the first sensing node and the first sensing assistance information corresponding to the second sensing node to the sensing control node, or may transmit the first sensing assistance information corresponding to the first sensing node and the first sensing assistance information corresponding to the second sensing node to the sensing control node together.

Optionally, the method shown in FIG. 7 may further include S711 and/or S712.

S711: The sensed target receives configuration information corresponding to the first sensing node. The sensed target may transmit, based on the configuration information corresponding to the first sensing node, the first sensing assistance information corresponding to the first sensing node.

S712: The sensed target receives configuration information corresponding to the second sensing node. The sensed target may transmit, based on the configuration information corresponding to the second sensing node, the first sensing assistance information corresponding to the second sensing node.

### Embodiment 4

FIG. 8 is a schematic flowchart of a wireless communication method according to Embodiment 4. In FIG. 8, a first node may be a first terminal device. The first terminal device may be a first sensing node. A sensing control node may be an access network device.

The method shown in FIG. 8 may include S820.

S820: The first terminal device sends first sensing assistance information corresponding to the first sensing node to the access network device.

Optionally, the method shown in FIG. 8 may further include S810.

S810: The first terminal device receives configuration information sent by the access network device. The first terminal device may transmit the first sensing assistance information based on the configuration information.

### Embodiment 5

FIG. 9 is a schematic flowchart of a wireless communication method according to Embodiment 5. In FIG. 9, a first sensing node may be a first terminal device. A sensing control node may be a core network device.

The method shown in FIG. 9 may include S920.

S920: The first terminal device sends first sensing assistance information corresponding to the first sensing node to the core network device.

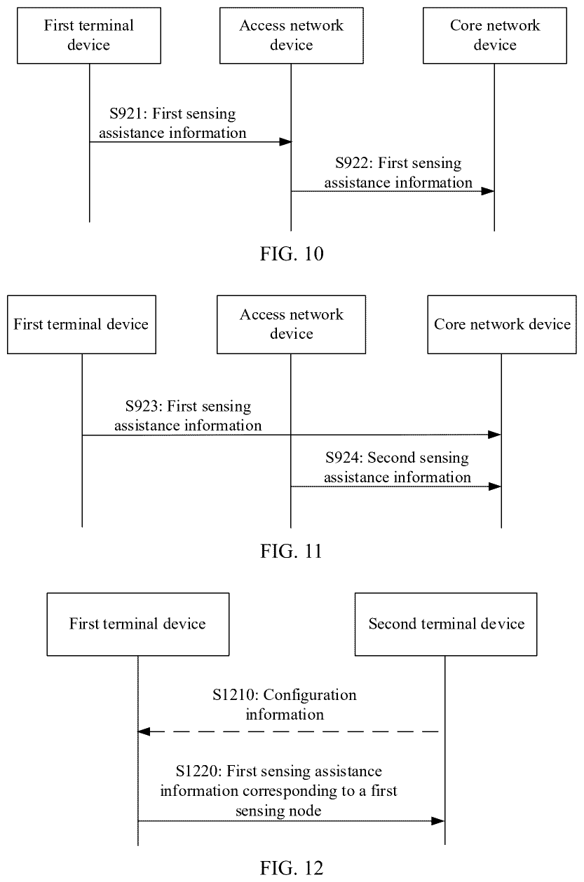

FIG. 10 and FIG. 11 are schematic flowcharts of possible implementations of S920 according to Embodiment 5. The methods shown in FIG. 10 and FIG. 11 may be implemented by the first terminal device, an access network device, and the core network device.

In the method shown in FIG. 10, S920 may include S921 and S922.

S921: The first terminal device sends the first sensing assistance information corresponding to the first sensing node to the access network device.

S922: The access network device sends the received first sensing assistance information to the core network device.

It can be understood that in the method shown in FIG. 10, the access network device may serve as a forwarding device to forward the first sensing assistance information corresponding to the first sensing node to the core network device.

In the method shown in FIG. 11, S920 may include S923 and S924.

S923: The first terminal device sends the first sensing assistance information corresponding to the first sensing node to the core network device.

S924: The access network device sends second sensing assistance information corresponding to the first sensing node to the core network device.

The second sensing assistance information may be partial information of the first terminal device stored in the access network device. For example, the second sensing assistance information may include information such as channel quality and downlink traffic. In other words, the access network device may send the stored information of the first terminal device as the second sensing assistance information to the core network device.

Optionally, the method shown in FIG. 9 may further include S910.

S910: The first terminal device receives configuration information sent by the core network device. The first terminal device may transmit the first sensing assistance information based on the configuration information.

### Embodiment 6

FIG. 12 is a schematic flowchart of a wireless communication method according to Embodiment 6. In FIG. 12, a first node may be a first terminal device, the first terminal device may be a first sensing node, and a sensing control node may be a second terminal device.

The method shown in FIG. 12 may include S1220.

S1220: The first terminal device sends first sensing assistance information corresponding to the first sensing node to the second terminal device.

Optionally, the method shown in FIG. 12 may further include S1210.

S1210: The first terminal device receives configuration information sent by the second terminal device. The first terminal device may transmit the first sensing assistance information based on the configuration information.

It can be understood that information may be transmitted between the first terminal device and the second terminal device through a sidelink. For example, the first terminal device may send the first sensing assistance information corresponding to the first sensing node to the second terminal device through a sidelink. For another example, the second terminal device may send the configuration information to the first terminal device through a sidelink.

### Embodiment 7

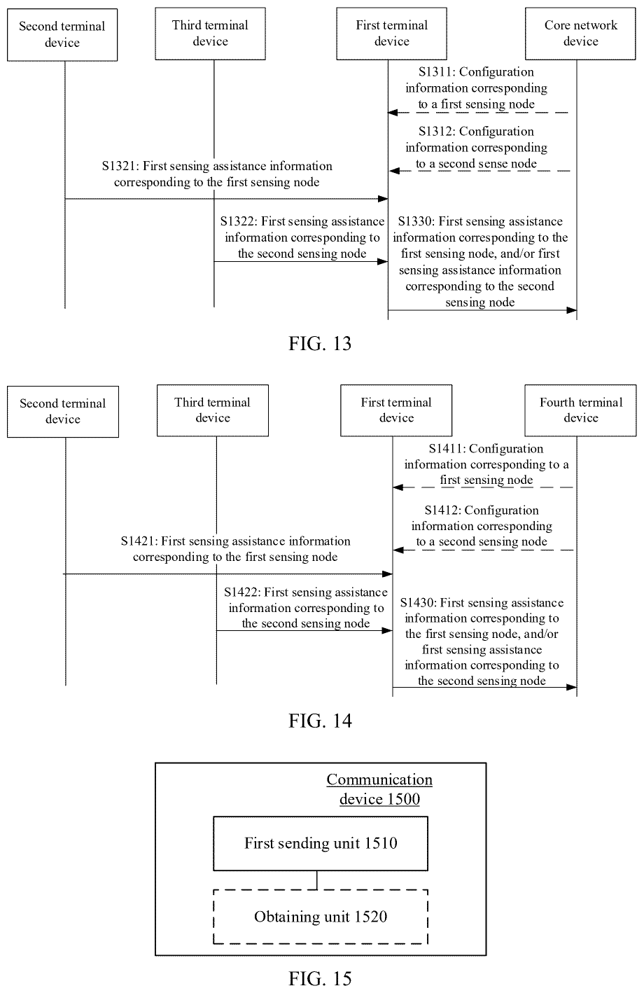

FIG. 13 is a schematic flowchart of a wireless communication method according to Embodiment 7. In FIG. 13, a first node may be a first terminal device, and the first terminal device may be a sensed target. A scenario related in the method shown in FIG. 13 may include a plurality of sensing nodes. The plurality of sensing nodes may include a first sensing node and a second sensing node. A second terminal device may be the first sensing node. A third terminal device may be the second sensing node. A core network device may be a sensing control node.

The method shown in FIG. 13 may include S1321, S1322, and S1330.

S1321: The second terminal device sends first sensing assistance information corresponding to the first sensing node to the first terminal device.

S1322: The third terminal device sends first sensing assistance information corresponding to the second sensing node to the first terminal device.

S1330: The first terminal device sends the first sensing assistance information corresponding to the first sensing node and/or the first sensing assistance information corresponding to the second sensing node to the core network device.

It can be understood that the first terminal device may separately transmit the first sensing assistance information corresponding to the first sensing node and the first sensing assistance information corresponding to the second sensing node to the sensing control node, or may transmit the first sensing assistance information corresponding to the first sensing node and the first sensing assistance information corresponding to the second sensing node to the sensing control node together.

Optionally, the method shown in FIG. 13 may further include S1311 and/or S1312.

S1311: The first terminal device receives configuration information corresponding to the first sensing node. The first terminal device may transmit, based on the configuration information corresponding to the first sensing node, the first sensing assistance information corresponding to the first sensing node.

S1312: The first terminal device receives configuration information corresponding to the second sensing node. The first terminal device may transmit, based on the configuration information corresponding to the second sensing node, the first sensing assistance information corresponding to the second sensing node.

### Embodiment 8

FIG. 14 is a schematic flowchart of a wireless communication method according to Embodiment 8. In FIG. 14, a first node may be a first terminal device, and the first terminal device may be a sensed target. A scenario related in the method shown in FIG. 14 may include a plurality of sensing nodes. The plurality of sensing nodes may include a first sensing node and a second sensing node. A second terminal device may be the first sensing node. A third terminal device may be the second sensing node. A fourth terminal device may be a sensing control node.

The method shown in FIG. 14 may include S1421, S1422, and S1430.

S1421: The second terminal device sends first sensing assistance information corresponding to the first sensing node to the first terminal device.

S1422: The third terminal device sends first sensing assistance information corresponding to the second sensing node to the first terminal device.

S1430: The first terminal device sends the first sensing assistance information corresponding to the first sensing node and/or the first sensing assistance information corresponding to the second sensing node to the fourth terminal device.

It can be understood that the first terminal device may separately transmit the first sensing assistance information corresponding to the first sensing node and the first sensing assistance information corresponding to the second sensing node to the sensing control node, or may transmit the first sensing assistance information corresponding to the first sensing node and the first sensing assistance information corresponding to the second sensing node to the sensing control node together.

Optionally, the method shown in FIG. 14 may further include S1411 and/or S1412.

S1411: The first terminal device receives configuration information corresponding to the first sensing node. The first terminal device may transmit, based on the configuration information corresponding to the first sensing node, the first sensing assistance information corresponding to the first sensing node.

S1412: The first terminal device receives configuration information corresponding to the second sensing node. The first terminal device may transmit, based on the configuration information corresponding to the second sensing node, the first sensing assistance information corresponding to the second sensing node.

The method embodiments of this application are described in detail above with reference to FIG. 1 to FIG. 14. Apparatus embodiments of this application are described in detail below with reference to FIG. 15 to FIG. 17. It should be understood that the description of the method embodiments corresponds to the description of the apparatus embodiments, and therefore, for parts that are not described in detail, reference may be made to the foregoing method embodiments.

FIG. 15 is a schematic diagram of a structure of a communication device 1500 according to an embodiment of this application. The communication device 1500 shown in FIG. 15 may be a first node. The communication device 1500 may include a first sending unit 1510.

The first sending unit 1510 is configured to send first sensing assistance information corresponding to a first sensing node; where the first sensing assistance information includes one or more of the following information of the first sensing node: sensing capability information, operating bandwidth information, sensing precision information, transmit power information, electric quantity information, resource occupancy information, indication information of expecting or not expecting to participate in sensing, location information, or information for matching with sensed targets.

In some embodiments, the sensing capability information includes one or more of the following information: sensing capability indication information, where the sensing capability indication information is used to indicate whether the first sensing node has a sensing capability; or a sensing capability level.

In some embodiments, the sensing capability includes one or more of the following capabilities: a capability of sending a sensing signal; a capability of receiving a sensing signal; or a capability of processing a sensing signal.

In some embodiments, the operating bandwidth information includes one or more of the following information: an operating bandwidth of the first sensing node, or a bandwidth of a sensing signal transmitted by the first sensing node.

In some embodiments, the sensing precision information includes one or more of the following information: measurement precision, measurement result quantification precision, or antenna information.

In some embodiments, the resource occupancy information includes one or more of the following information: traffic information, channel state information of a link associated with the first sensing node, or time-frequency resource information.

In some embodiments, the indication information of expecting or not expecting to participate in sensing includes one or more of the following: indication information of expecting or not expecting to participate in sending a sensing signal; indication information of expecting or not expecting to participate in receiving a sensing signal; information about a sensed target expected or not expected for participating in sensing; or information about a sensing service expected or not expected for participating in sensing.

In some embodiments, the information for matching with sensed targets may include one or more of the following: a sensing service list, a sensing node list, or a sensed target list.

In some embodiments, the sensing service list includes one or more of the following lists for the first sensing node: a list of services expected for sensing, a list of services capable of being sensed, a list of services allowed for sensing, a list of services not expected for sensing, a list of services incapable of being sensed, or a list of services not allowed to be sensed; and/or the sensing node list includes one or more of the following lists for a sensed target: a first list, a second list, a third list, a fourth list, a fifth list, or a sixth list, where the sensed target expects to be sensed by any sensing node in the first list, the sensed target is capable of being sensed by any sensing node in the second list, the sensed target is allowed to be sensed by any sensing node in the third list, the sensed target does not expected to be sensed by any sensing node in the fourth list, the sensed target is incapable of being sensed by any sensing node in the fifth list, and the sensed target is not allowed to be sensed by any sensing node in the sixth list; and/or the sensed target list includes one or more of the following lists for the first sensing node: a list of sensed targets expected for sensing, a list of sensed targets capable of being sensed, a list of sensed targets allowed to be sensed, a list of sensed targets not expected for sensing, a list of sensed targets incapable of being sensed, or a list of sensed targets not allowed to be sensed.

In some embodiments, the first sending unit 1510 is specifically configured to send the first sensing assistance information based on configuration information.

In some embodiments, the communication device 1500 may further include an obtaining unit 1520, configured to obtain the configuration information.

In some embodiments, the configuration information is used to configure one or more of the following: content included in the first sensing assistance information, resource information used for transmission of the first sensing assistance information, an identifier of the first sensing node, or a type of the first sensing node.

In some embodiments, the resource information includes one or more of the following: a transmission cut-off time of the first sensing assistance information, information about a time unit occupied by the first sensing assistance information, or a frequency domain resource occupied by the first sensing assistance information.

In some embodiments, the transmission cut-off time includes a first time unit and/or a first time length, the first time unit is used to indicate that the first sensing assistance information is sent no later than the first time unit, the first time length is used to indicate that the first sensing assistance information is sent no later than a second time unit, where the second time unit is determined based on the first time length and a first reference time unit, and the first reference time unit is a time unit occupied by the configuration information.

In some embodiments, the information about a time unit includes a number of an absolute time unit occupied by the first sensing assistance information, and/or a time offset of a time unit occupied by the first sensing assistance information relative to the time unit occupied by the configuration information.

In some embodiments, the frequency resource occupied by the first sensing assistance information is determined based on a time domain resource and/or a frequency domain resource occupied by the configuration information.

In some embodiments, the first node is the first sensing node or a sensed target.

In some embodiments, if the first node is the sensed target, the communication device further includes: a first receiving unit, configured to receive pieces of first sensing assistance information respectively corresponding to one or more sensing nodes, where the one or more sensing nodes include the first sensing node.

In some embodiments, in a case that the first node receives pieces of first sensing assistance information respectively corresponding to a plurality of sensing nodes, the pieces of first sensing assistance information respectively corresponding to the plurality of sensing nodes are sent by the first node through a same resource or channel; the pieces of first sensing assistance information respectively corresponding to the plurality of sensing nodes are sent by the first node respectively through independent resources or channels; or the pieces of first sensing assistance information respectively corresponding to the plurality of sensing nodes are grouped into at least one group, and pieces of first sensing assistance information in a same group are sent by the first node through a same resource or channel.

In some embodiments, the first node is a first terminal device or an access network device.

In some embodiments, if the first sensing node is a second terminal device, the first sensing assistance information includes uplink information of the second terminal device.

In some embodiments, downlink information of the second terminal device is included in second sensing assistance information corresponding to the first sensing node, and the second sensing assistance information is sent by the access network device.

In some embodiments, the uplink information indicates an uplink radio resource occupancy status of the second terminal device, and the downlink information indicates a downlink radio resource occupancy status of the second terminal device.

In some embodiments, that the first node sends the first sensing assistance information corresponding to the first sensing node includes: the first node sends the first sensing assistance information to a sensing control node.

In some embodiments, that the first node sends the first sensing assistance information corresponding to the first sensing node to the sensing control node includes: the first node sends the first sensing assistance information to the sensing control node through a sensed target.

In some embodiments, the sensing control node is a sensing node or a sensed target, or a separate node other than a sensing node and a sensed target.

In some embodiments, the sensing control node is a terminal device, an access network device or a core network device.

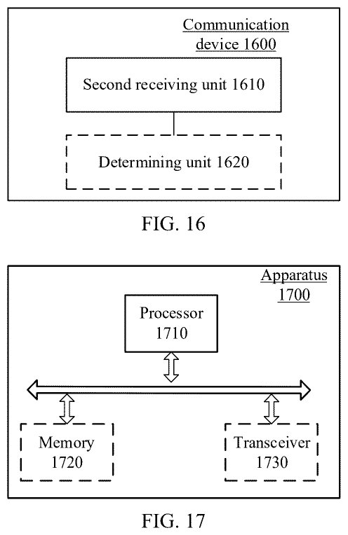

FIG. 16 is a schematic diagram of a structure of another communication device 1600 according to an embodiment of this application. The communication device 1600 may be a sensing control node. The communication device 1600 may include a second receiving unit 1610.

The second receiving unit 1610 is configured to receive first sensing assistance information corresponding to a first sensing node and sent by a first node; where the first sensing assistance information includes one or more of the following information of the first sensing node: sensing capability information, operating bandwidth information, sensing precision information, transmit power information, electric quantity information, resource occupancy information, indication information of expecting or not expecting to participate in sensing, location information, or information for matching with sensed targets.

In some embodiments, the sensing capability information includes one or more of the following information: sensing capability indication information, where the sensing capability indication information is used to indicate whether the first sensing node has a sensing capability; or a sensing capability level.

In some embodiments, the sensing capability includes one or more of the following capabilities: a capability of sending a sensing signal; a capability of receiving a sensing signal; or a capability of processing a sensing signal.

In some embodiments, the operating bandwidth information includes one or more of the following information: an operating bandwidth of the first sensing node, or a bandwidth of a sensing signal transmitted by the first sensing node.

In some embodiments, the sensing precision information includes one or more of the following information: measurement precision, measurement result quantification precision, or antenna information.

In some embodiments, the resource occupancy information includes one or more of the following information: traffic information, channel state information of a link associated with the first sensing node, or time-frequency resource information.

In some embodiments, the indication information of expecting or not expecting to participate in sensing includes one or more of the following: indication information of expecting or not expecting to participate in sending a sensing signal; indication information of expecting or not expecting to participate in receiving a sensing signal; information about a sensed target expected or not expected for participating in sensing; or information about a sensing service expected or not expected for participating in sensing.

In some embodiments, the information for matching with sensed targets may include one or more of the following: a sensing service list, a sensing node list, or a sensed target list.

In some embodiments, the sensing service list includes one or more of the following lists for the first sensing node: a list of services expected for sensing, a list of services capable of being sensed, a list of services allowed for sensing, a list of services not expected for sensing, a list of services incapable of being sensed, or a list of services not allowed to be sensed; and/or the sensing node list includes one or more of the following lists for a sensed target: a first list, a second list, a third list, a fourth list, a fifth list, or a sixth list, where the sensed target expects to be sensed by any sensing node in the first list, the sensed target is capable of being sensed by any sensing node in the second list, the sensed target is allowed to be sensed by any sensing node in the third list, the sensed target does not expected to be sensed by any sensing node in the fourth list, the sensed target is incapable of being sensed by any sensing node in the fifth list, and the sensed target is not allowed to be sensed by any sensing node in the sixth list; and/or the sensed target list includes one or more of the following lists for the first sensing node: a list of sensed targets expected for sensing, a list of sensed targets capable of being sensed, a list of sensed targets allowed to be sensed, a list of sensed targets not expected for sensing, a list of sensed targets incapable of being sensed, or a list of sensed targets not allowed to be sensed.

In some embodiments, the second receiving unit 1610 may be specifically configured to receive the first sensing assistance information based on configuration information. In some embodiments, the communication device 1600 may further include at least one of a determining unit 1620 and a second sending unit, where the determining unit 1620 may be configured to determine the configuration information, and the second sending unit may be configured to send the configuration information.

In some embodiments, the configuration information is used to configure one or more of the following: content included in the first sensing assistance information, resource information used for transmission of the first sensing assistance information, an identifier of the first sensing node, or a type of the first sensing node.

In some embodiments, the resource information includes one or more of the following: a transmission cut-off time of the first sensing assistance information, information about a time unit occupied by the first sensing assistance information, or a frequency domain resource occupied by the first sensing assistance information.

In some embodiments, the transmission cut-off time includes a first time unit and/or a first time length, the first time unit is used to indicate that the first sensing assistance information is sent no later than the first time unit, the first time length is used to indicate that the first sensing assistance information is sent no later than a second time unit, where the second time unit is determined based on the first time length and a first reference time unit, and the first reference time unit is a time unit occupied by the configuration information.

In some embodiments, the information about a time unit includes a number of an absolute time unit occupied by the first sensing assistance information, and/or a time offset of a time unit occupied by the first sensing assistance information relative to the time unit occupied by the configuration information.

In some embodiments, the frequency resource occupied by the first sensing assistance information is determined based on a time domain resource and/or a frequency domain resource occupied by the configuration information.

In some embodiments, the first node is the first sensing node or a sensed target.

In some embodiments, the first node is a first terminal device or an access network device.

In some embodiments, if the first sensing node is a second terminal device, the first sensing assistance information includes uplink information of the second terminal device.

In some embodiments, downlink information of the second terminal device is included in second sensing assistance information corresponding to the first sensing node, and the second sensing assistance information is sent by the access network device.

In some embodiments, the uplink information indicates an uplink radio resource occupancy status of the second terminal device, and the downlink information indicates a downlink radio resource occupancy status of the second terminal device.

In some embodiments, that the sensing control node receives first sensing assistance information corresponding to the first sensing node and sent by the first node includes: the sensing control node receives the first sensing assistance information through a sensed target.

In some embodiments, the sensing control node is a sensing node or a sensed target, or a separate node other than a sensing node and a sensed target.

In some embodiments, the sensing control node is a terminal device, an access network device or a core network device.

FIG. 17 is a schematic diagram of a structure of a communication apparatus according to an embodiment of this application. The dashed lines in FIG. 17 indicate that the unit or module is optional. The apparatus 1700 may be configured to implement the methods described in the foregoing method embodiments. The apparatus 1700 may be a chip, a terminal device, an access network device, or a core network device. The apparatus 1700 may be a first node, a first sensing node, a sensed target, or a sensing control node.

The apparatus 1700 may include one or more processors 1710. The processor 1710 may support the apparatus 1700 to implement the methods described in the foregoing method embodiments. The processor 1710 may be a general-purpose processor or a dedicated processor. For example, the processor may be a central processing unit (CPU). Alternatively, the processor may be another general-purpose processor, a digital signal processor (digital signal processor, DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 1700 may further include one or more memories 1720. The memory 1720 stores a program that may be executed by the processor 1710, so that the processor 1710 performs the method described in the foregoing method embodiments. The memory 1720 may be independent of the processor 1710 or may be integrated into the processor 1710.

The apparatus 1700 may further include a transceiver 1730. The processor 1710 may communicate with another device or chip through the transceiver 1730. For example, the processor 1710 may transmit data to and receive data from another device or chip by using the transceiver 1730.

In some embodiments, the first sending unit 1510 in FIG. 15 may be the transceiver 1730 in FIG. 17, and the transceiver 1730 may be configured to send first sensing assistance information corresponding to the first sensing node. The obtaining unit 1520 may be the processor 1710 in FIG. 17, and the processor 1710 may be configured to obtain configuration information. The first receiving unit may be the transceiver 1730 in FIG. 17, and the transceiver 1730 may be configured to receive pieces of first sensing assistance information respectively corresponding to one or more sensing nodes, where the one or more sensing nodes include the first sensing node.

In some embodiments, the second receiving unit 1610 in FIG. 16 may be the transceiver 1730 in FIG. 17, and the transceiver 1730 may be configured to receive the first sensing assistance information corresponding to the first sensing node and sent by the first node. The determining unit 1620 may be the processor 1710 in FIG. 17, and the processor 1710 may be configured to determine configuration information. The second sending unit may be the transceiver 1730 in FIG. 17, and the transceiver 1730 may be configured to send the configuration information. An embodiment of this application further provides a computer-readable storage medium for storing a program. The computer-readable storage medium may be applied to a communication device provided in embodiments of this application, and the program causes a computer to perform the methods performed by the communication device in various embodiments of this application.

An embodiment of this application further provides a computer program product. The computer program product includes a program. The computer program product may be applied to a communication device provided in embodiments of this application, and the program causes a computer to perform the methods performed by the communication device in various embodiments of this application.

An embodiment of this application further provides a computer program. The computer program may be applied to the communication device provided in embodiments of this application, and the computer program causes a computer to perform the methods performed by the terminal or the network device in various embodiments of this application.

It should be understood that the terms “system” and “network” in this application may be used interchangeably. In addition, the terms used in this application are only used to explain the specific embodiments of this application, and are not intended to limit this application. The terms “first”, “second”, “third”, “fourth”, and the like in the specification, claims, and drawings of this application are used to distinguish between different objects, rather than to describe a specific order. In addition, the terms “include” and “have” and any variations thereof are intended to cover a non-exclusive inclusion.

In embodiments of this application, “indicate” mentioned herein may refer to a direct indication, or may refer to an indirect indication, or may mean that there is an association relationship. For example, A indicates B, which may mean that A directly indicates B, for example, B may be obtained by means of A; or may mean that A indirectly indicates B, for example, A indicates C, and B may be obtained by means of C; or may mean that there is an association relationship between A and B.

In embodiments of this application, “B corresponding to A” means that B is associated with A, and B may be determined based on A. However, it should be further understood that, determining B based on A does not mean determining B based only on A, but instead, B may be determined based on A and/or other information.

In embodiments of this application, the term “correspond” may mean that there is a direct or indirect correspondence between the two, or may mean that there is an association relationship between the two, or may mean that there is a relationship such as indicating and being indicated, or configuring and being configured.

In embodiments of this application, “predefined” or “pre-configured” may be implemented by pre-storing corresponding code, tables, or other forms that may be used to indicate related information in devices (for example, including a terminal device and a network device), and a specific implementation thereof is not limited in this application. For example, being pre-defined may refer to being defined in a protocol.

In embodiments of this application, the “protocol” may refer to a standard protocol in the communications field, and may include, for example, an LTE protocol, an NR protocol, and a related protocol applied to a future communication system, which is not limited in this application.

In embodiments of this application, the term “and/or” is merely an association relationship that describes associated objects, and represents that there may be three relationships. For example, A and/or B may represent three cases: only A exists, both A and B exist, and only B exists. In addition, the character “/” in the specification generally indicates an “or” relationship between the associated objects.

In embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interfaces, apparatus or units, and may be implemented in electronic, mechanical, or other forms.

The units described as separate components may be or may not be physically separated, and the components displayed as units may be or may not be physical units, that is, may be located in one place or distributed on a plurality of network units. Some or all of the units may be selected according to actual requirements to achieve the objectives of the solutions of embodiments.

In addition, functional units in embodiments of this application may be integrated into one processing unit, each of the units may exist alone physically, or two or more units are integrated into one unit.

All or some of the foregoing embodiments may be implemented by using software, hardware, firmware, or any combination thereof. When software is used for implementation, the method may be implemented completely or partially in the form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A wireless communication device, comprising at least one processor, and at least one memory including computer program, wherein the at least one memory and the at least one processor are configured with the computer program, to cause the wireless communication device at least to:
send first sensing assistance information corresponding to a first sensing node;
wherein the wireless communication device is a first node, the first sensing assistance information comprises one or more of following information of the first sensing node:
sensing capability information, operating bandwidth information, sensing precision information, transmit power information, electric quantity information, resource occupancy information, indication information of expecting or not expecting to participate in sensing, location information, or information for matching with sensed targets.

2. The wireless communication device according to claim 1, wherein the sensing capability information comprises one or more of following information:
sensing capability indication information, wherein the sensing capability indication information is used to indicate whether the first sensing node has a sensing capability, wherein the sensing capability comprises one or more of following capabilities: a capability of sending a sensing signal; a capability of receiving a sensing signal; or a capability of processing a sensing signal; or
a sensing capability level.

3. The wireless communication device according to claim 1, wherein the operating bandwidth information comprises one or more of following information:
an operating bandwidth of the first sensing node; or
a bandwidth of a sensing signal transmitted by the first sensing node.

4. The wireless communication device according to claim 1, wherein the sensing precision information comprises one or more of following information: measurement precision, measurement result quantification precision, or antenna information.

5. The wireless communication device according to claim 1, wherein the resource occupancy information comprises one or more of following information: traffic information, channel state information of a link associated with the first sensing node, or time-frequency resource information.

6. The wireless communication device according to claim 1, wherein the indication information of expecting or not expecting to participate in sensing comprises one or more of following:
indication information of expecting or not expecting to participate in sending a sensing signal;
indication information of expecting or not expecting to participate in receiving a sensing signal;
information about a sensed target expected or not expected for participating in sensing; or
information about a sensing service expected or not expected for participating in sensing.

7. The wireless communication device according to claim 1, wherein the information for matching with sensed targets comprises one or more of following: a sensing service list, a sensing node list, or a sensed target list,
wherein
the sensing service list comprises one or more of following lists for the first sensing node: a list of services expected for sensing, a list of services capable of being sensed, a list of services allowed to be sensed, a list of services not expected for sensing, a list of services incapable of being sensed, or a list of services not allowed to be sensed; and/or
the sensing node list comprises one or more of following lists for a sensed target: a first list, a second list, a third list, a fourth list, a fifth list, or a sixth list, wherein the sensed target expects to be sensed by any sensing node in the first list, the sensed target is capable of being sensed by any sensing node in the second list, the sensed target is allowed to be sensed by any sensing node in the third list, the sensed target does not expected to be sensed by any sensing node in the fourth list, the sensed target is incapable of being sensed by any sensing node in the fifth list, and the sensed target is not allowed to be sensed by any sensing node in the sixth list; and/or
the sensed target list comprises one or more of following lists for the first sensing node: a list of sensed targets expected for sensing, a list of sensed targets capable of being sensed, a list of sensed targets allowed to be sensed, a list of sensed targets not expected for sensing, a list of sensed targets incapable of being sensed, or a list of sensed targets not allowed to be sensed.

8. The wireless communication device according to claim 1, wherein the wireless communication device is further caused to:
send the first sensing assistance information based on configuration information,
wherein the configuration information is used to configure one or more of following:
content comprised in the first sensing assistance information;
resource information used for transmission of the first sensing assistance information;
an identifier of the first sensing node; or
a type of the first sensing node.

9. The wireless communication device according to claim 8, wherein the resource information comprises one or more of following: a transmission cut-off time of the first sensing assistance information, information about a time unit occupied by the first sensing assistance information, or a frequency domain resource occupied by the first sensing assistance information,
wherein
the transmission cut-off time comprises a first time unit and/or a first time length, the first time unit is used to indicate that the first sensing assistance information is sent no later than the first time unit, the first time length is used to indicate that the first sensing assistance information is sent no later than a second time unit, wherein the second time unit is determined based on the first time length and a first reference time unit, and the first reference time unit is a time unit occupied by the configuration information.

10. The wireless communication device according to claim 1, wherein the first node is the first sensing node or a sensed target.

11. The wireless communication device according to claim 10, wherein if the first node is the sensed target, the computer program causes the wireless communication device to perform:
receiving pieces of first sensing assistance information respectively corresponding to one or more sensing nodes, wherein the one or more sensing nodes comprise the first sensing node;
wherein in a case that the first node receives pieces of first sensing assistance information respectively corresponding to a plurality of sensing nodes,
the pieces of first sensing assistance information respectively corresponding to the plurality of sensing nodes are sent by the first node through a same resource or channel; or
the pieces of first sensing assistance information respectively corresponding to the plurality of sensing nodes are sent by the first node respectively through independent resources or channels; or
the pieces of first sensing assistance information respectively corresponding to the plurality of sensing nodes are grouped into at least one group, and pieces of first sensing assistance information in a same group are sent by the first node through a same resource or channel.

12. The wireless communication device according to claim 1, wherein the first node is a first terminal device or an access network device.

13. The wireless communication device according to claim 12, wherein the first sensing node is a second terminal device, the first sensing assistance information comprises uplink information of the second terminal device,
wherein downlink information of the second terminal device is comprised in second sensing assistance information corresponding to the first sensing node, and the second sensing assistance information is sent by the access network device,
wherein the uplink information indicates an uplink radio resource occupancy status of the second terminal device, and the downlink information indicates a downlink radio resource occupancy status of the second terminal device.

14. A wireless communication device, comprising at least one processor, and at least one memory including computer program, wherein the at least one memory and the at least one processor are configured with the computer program, to cause the wireless communication device at least to:
receive first sensing assistance information corresponding to a first sensing node and sent by a first node;
wherein the wireless communication device is a sensing control node, the first sensing assistance information comprises one or more of following information of the first sensing node:
sensing capability information, operating bandwidth information, sensing precision information, transmit power information, electric quantity information, resource occupancy information, indication information of expecting or not expecting to participate in sensing, location information, or information for matching with sensed targets.

15. The wireless communication device according to claim 14, wherein the sensing capability information comprises one or more of following information:
sensing capability indication information, wherein the sensing capability indication information is used to indicate whether the first sensing node has a sensing capability, wherein the sensing capability comprises one or more of following capabilities: a capability of sending a sensing signal; a capability of receiving a sensing signal; or a capability of processing a sensing signal; or
a sensing capability level.

16. The wireless communication device according to claim 14, wherein the operating bandwidth information comprises one or more of following information:
an operating bandwidth of the first sensing node; or
a bandwidth of a sensing signal transmitted by the first sensing node.

17. The wireless communication device according to claim 14, wherein the sensing precision information comprises one or more of following information: measurement precision, measurement result quantification precision, or antenna information; and/or
wherein the resource occupancy information comprises one or more of following information: traffic information, channel state information of a link associated with the first sensing node, or time-frequency resource information.

18. The wireless communication device according to claim 14, wherein the indication information of expecting or not expecting to participate in sensing comprises one or more of following:
indication information of expecting or not expecting to participate in sending a sensing signal;
indication information of expecting or not expecting to participate in receiving a sensing signal;
information about a sensed target expected or not expected for participating in sensing; or
information about a sensing service expected or not expected for participating in sensing.

19. The wireless communication device according to claim 14, wherein the information for matching with sensed targets comprises one or more of following: a sensing service list, a sensing node list, or a sensed target list,
wherein
the sensing service list comprises one or more of following lists for the first sensing node: a list of services expected for sensing, a list of services capable of being sensed, a list of services allowed to be sensed, a list of services not expected for sensing, a list of services incapable of being sensed, or a list of services not allowed to be sensed; and/or
the sensing node list comprises one or more of following lists for a sensed target: a first list, a second list, a third list, a fourth list, a fifth list, or a sixth list, wherein the sensed target expects to be sensed by any sensing node in the first list, the sensed target is capable of being sensed by any sensing node in the second list, the sensed target is allowed to be sensed by any sensing node in the third list, the sensed target does not expected to be sensed by any sensing node in the fourth list, the sensed target is incapable of being sensed by any sensing node in the fifth list, and the sensed target is not allowed to be sensed by any sensing node in the sixth list; and/or
the sensed target list comprises one or more of following lists for the first sensing node: a list of sensed targets expected for sensing, a list of sensed targets capable of being sensed, a list of sensed targets allowed to be sensed, a list of sensed targets not expected for sensing, a list of sensed targets incapable of being sensed, or a list of sensed targets not allowed to be sensed.

20. A wireless communication method, comprising:
sending, by a first node, first sensing assistance information corresponding to a first sensing node;
wherein the first sensing assistance information comprises one or more of following information of the first sensing node:
sensing capability information, operating bandwidth information, sensing precision information, transmit power information, electric quantity information, resource occupancy information, indication information of expecting or not expecting to participate in sensing, location information, or information for matching with sensed targets.
